(19) United States
(12) Patent Application Publication
(10) Pub. No.: US 2026/0267937 A1
(43) Pub. Date: Sep. 10, 2026

(54) SYSTEMS AND METHODS FOR RELATIVISTIC ZERO-KNOWLEDGE PROOF OF KNOWLEDGE FOR SHORT INTEGER SOLUTION PROBLEM

(71) Applicant: JPMORGAN CHASE BANK, N.A., New York, NY (US)

(72) Inventors: Kaiyan SHI, Greenbelt, MD (US); Omar AMER, New York, NY (US); Kaushik CHAKRABORTY, Singapore (SG); Lim Ci WEN, Singapore (SG); Marco PISTOIA, New York, NY (US); Yao MA, Guangdong (CN)

(21) Appl. No.: 19/071,533

(22) Filed: Mar. 5, 2025

(51) Int. Cl. G06F 17/16

(52) U.S. Cl. CPC G06F 17/16

(57) ABSTRACT

A method may include: a first prover generating a short vector that is known only to the first prover and a matrix, computing a product vector from the matrix and the short vector, and sharing, the matrix and the product vector with a second prover and a verifier; the first prover and the second prover agreeing to a first and a second random vector; the verifier generating and sending a first random string to the second prover, and generating and sending a second random string to the first prover; the second prover computing and sending a commitment vector to the verifier; the first prover computing and sending a first prover vector to the verifier; the verifier verifying that the first prover response and the second prover response match, and outputting a value indicating whether the verification was successful.

### BACKGROUND OF THE INVENTION

### 1. Field of the Invention

Embodiments relate to systems and methods for relativistic zero-knowledge proof of knowledge for short integer solution problem.

### 2. Description of the Related Art

Short integer solution is an average-case problems that is used in lattice-based cryptography constructions. Average case problems are the problems that are hard to be solved for some randomly selected instances. For example, given a matrix [symbol] and vector \vec{u}, it is hard to find a nonzero satisfying short vector S such that the matrix maps this short vector to the given vector, i.e., [symbol] \vec{s}=\vec{u}. For cryptography applications, worst case complexity is not sufficient, as there is a need to guarantee that cryptographic construction is hard based on average case complexity.

### SUMMARY OF THE INVENTION

Systems and methods for relativistic zero-knowledge proof of knowledge for short integer solution problem are disclosed. In one embodiment, a method may include: (1) generating, by a first prover, a matrix and a short vector, wherein the matrix comprises elements from a finite field of non-negative integers modulo q and the short vector has a bounded length, and the short vector is known only to the first prover; (2) computing, by the first prover, a product vector from the matrix and the short vector; (3) sharing, by the first prover, the matrix and the product vector with a second prover and a verifier; (4) agreeing, by the first prover and the second prover, to a first random vector and a second random vector; (5) generating, by the verifier, a first random string from a challenge space and a second random string from the finite field of non-negative integers modulo q; (6) sending, by the verifier, the first random string to the second prover and the second random string to the first prover; (7) computing, by the second prover, a commitment vector based on the second random string, the matrix, the first random vector, and the second random vector; (8) sending, by the second prover, a second prover response comprising the commitment vector to the verifier; (9) computing, by the first prover, a first prover vector based on the first random string, the short vector and the first random vector; (10) sending, by the first prover, a first prover response comprising the first prover vector and the second random vector to the verifier; (11) verifying, by the verifier, that the first prover response and the second prover response match; (12) determining, by the verifier, that the first prover vector is bounded; and (13) outputting, by the verifier, a value indicating whether the verification was successful.

In one embodiment, the method may also include: confirming, by the verifier, that the first prover response and the second prover response were received within a time period.

In one embodiment, the time period is based on a distance between the first prover and the verifier, and the second prover and the verifier.

In one embodiment, the commitment vector comprises a product of the second random string, the matrix, and the first random vector plus the second random vector.

In one embodiment, the first prover vector comprises a product of the first random string and the short vector plus the first random vector.

In one embodiment, the first prover response and the second prover response match when the product of the second random string, the matrix, and the first prover vector is equal to the commitment vector minus the second random vector plus the product of the first random string, the second random string, and the product vector.

According to another embodiment, a method may include: (1) generating, by a first prover, a matrix and a short vector, wherein the matrix comprises elements from a finite field of non-negative integers modulo q and the short vector has a bounded length, and the short vector is known only to the first prover; (2) computing, by the first prover, a product vector from the matrix and the short vector; (3) sharing, by the first prover, the matrix and the product vector with a second prover and a verifier; (4) agreeing, by the first prover and the second prover, to a first random vector and a second random vector; (5) generating, by the verifier, a first random string from a challenge space and a second random string from the finite field; (6) sending, by the verifier, the first random string to the second prover and the second random string to the first prover; (7) computing, by the second prover, a commitment vector based on the second random string, the matrix, the first random vector, and the second random vector; (8) sending, by the second prover, a second prover response comprising the commitment vector to the verifier; (9) computing, by the first prover, a first prover vector based on the first random string, the short vector and the first random vector, and a second prover vector based on the matrix and the second random vector; (10) sending, by the first prover, a first prover response comprising the first prover vector and the second prover vector to the verifier; (11) verifying, by the verifier, that the first prover response and the second prover response match; (12) determining, by the verifier, that the first prover vector is bounded; and (13) outputting, by the verifier, a value indicating whether the verification was successful.

In one embodiment, the method may also include: confirming, by the verifier, that the first prover response and the second prover response were received within a time period.

In one embodiment, the time period is based on a distance between the first prover and the verifier, and the second prover and the verifier.

In one embodiment, the commitment vector comprises a product of the second random string, the matrix, and the first random vector plus the second random vector.

In one embodiment, the first prover vector comprises a product of the first random string and the short vector plus the first random vector, and the second prover vector comprises a product of the vector and the second random vector.

In one embodiment, the first prover response and the second prover response match when the product of the second random string, the matrix, and the first prover vector is equal to the product of the matrix and the commitment vector minus the product of the vector and the second random vector plus the product of the first random string, the second random string, and the product vector.

According to another embodiment, a system may include: a first prover electronic device executing a first prover computer program; a second prover electronic device executing a second prover computer program; a verifier electronic device executing a verifier computer program. The first prover computer program generates a matrix and a short vector, wherein the matrix comprises elements from a finite field of non-negative integers modulo q and the short vector has a bounded length, and the short vector is known only to the first prover; the first prover computer program computing a product vector from the matrix and the short vector; the first prover computer program shares the matrix and the product vector with the second prover computer program and the verifier computer program; the first prover computer program and the second prover computer program agree to a first random vector and a second random vector; the verifier computer program generates a first random string from a challenge space and a second random string from the finite field of non-negative integers modulo q; the verifier computer program sends the first random string to the second prover computer program and the second random string to the first prover computer program; the second prover computer program computes a commitment vector based on the second random string, the matrix, the first random vector, and the second random vector; the second prover computer program sends a second prover response comprising the commitment vector to the verifier; the first prover computer program computes a first prover vector based on the first random string, the short vector and the first random vector; the first prover computer program sends a first prover response comprising the first prover vector and the second random vector to the verifier computer program; the verifier computer program verifies that the first prover response and the second prover response match; the verifier computer program determines that the first prover vector is bounded; and the verifier computer program outputs a value indicating whether the verification was successful.

In one embodiment, the verifier computer program confirms that the first prover response and the second prover response were received within a time period.

In one embodiment, the time period is based on a distance between the first prover electronic device and the verifier electronic device, and the second prover electronic device and the verifier electronic device.

In one embodiment, the commitment vector comprises a product of the second random string, the matrix, and the first random vector plus the second random vector.

In one embodiment, the first prover vector comprises a product of the first random string and the short vector plus the first random vector.

In one embodiment, the first prover response and the second prover response match when the product of the second random string, the matrix, and the first prover vector is equal to the commitment vector minus the second random vector plus the product of the first random string, the second random string, and the product vector.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for relativistic zero-knowledge proof of knowledge for short integer solution problem according to an embodiment;

FIGS. 2A and 2B illustrate a method for relativistic zero-knowledge proof of knowledge for short integer solution problem according to an embodiment;

FIGS. 3A and 3B illustrate a method for relativistic zero-knowledge proof of knowledge for short integer solution problem according to another embodiment;

FIG. 4 depicts an exemplary computing system for implementing aspects of the present disclosure.

### DETAILED DESCRIPTION OF PREFERRED EMBODIMENTS

Embodiments relate to systems and methods for relativistic zero-knowledge proof of knowledge for short integer solution problem.

Embodiments provide a protocol by which provers must prove to a verifier that they know the short vector without leaking any information about this vector. Security may be based on both the lattice problem hardness and non-communication between provers.

In embodiments, the relativistic constraints on provers in terms of security may be guaranteed. For example, the verifier may be split into multiple agents as verifier electronic devices with the same number as provers, and the provers may interact with verifier electronic devices closely to initiate the protocol.

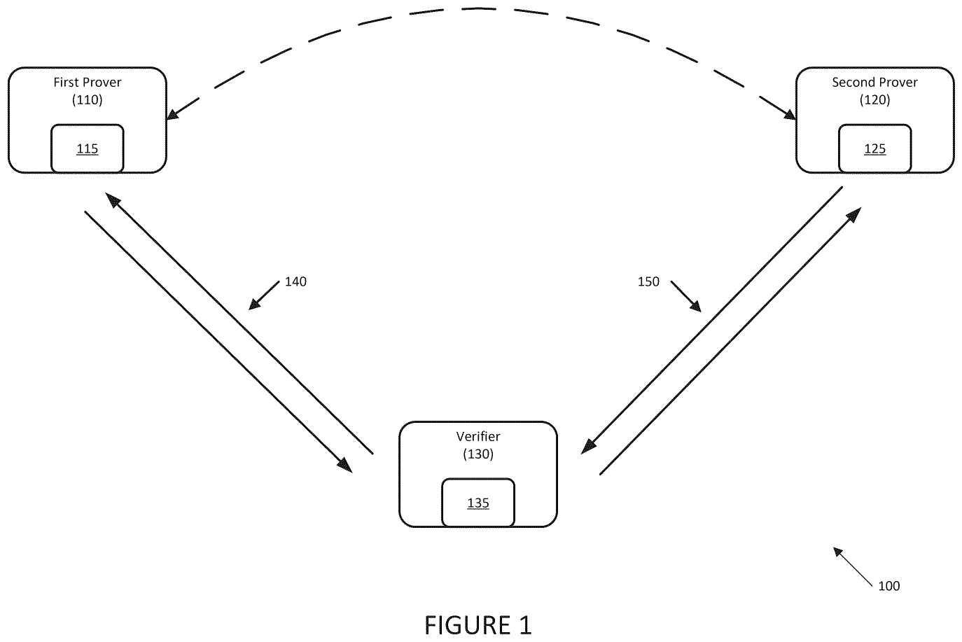

Referring to FIG. 1, a system for relativistic zero-knowledge proof of knowledge for short integer solution problem is disclosed according to an embodiment, System 100 may include first prover 110 and second prover 120. Provers 110 and 120 may be electronic devices, such as servers and computers (e.g., workstations, desktops, notebooks, laptops, tablets, etc.). First prover 110 may execute first prover computer program 115, and second prover 120 may execute second prover computer program 125.

In one embodiment first prover 110 and second prover 120 may share randomness.

System 100 may further include verifier 130, which may be an electronic device, such as a server and a computer (e.g., workstations, desktops, notebooks, laptops, tablets, etc.). Verifier 130 may execute verifier computer program 135. Verifier 130 may communicate with first prover 110 using first classical computer channel 140, and with second prover using second classical communication channel 150. Classical communication channels may include any suitable direct communication channel.

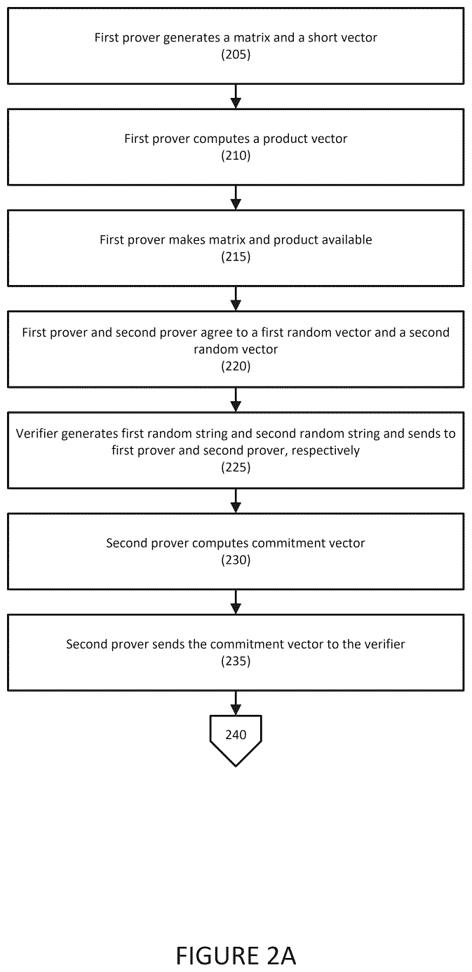

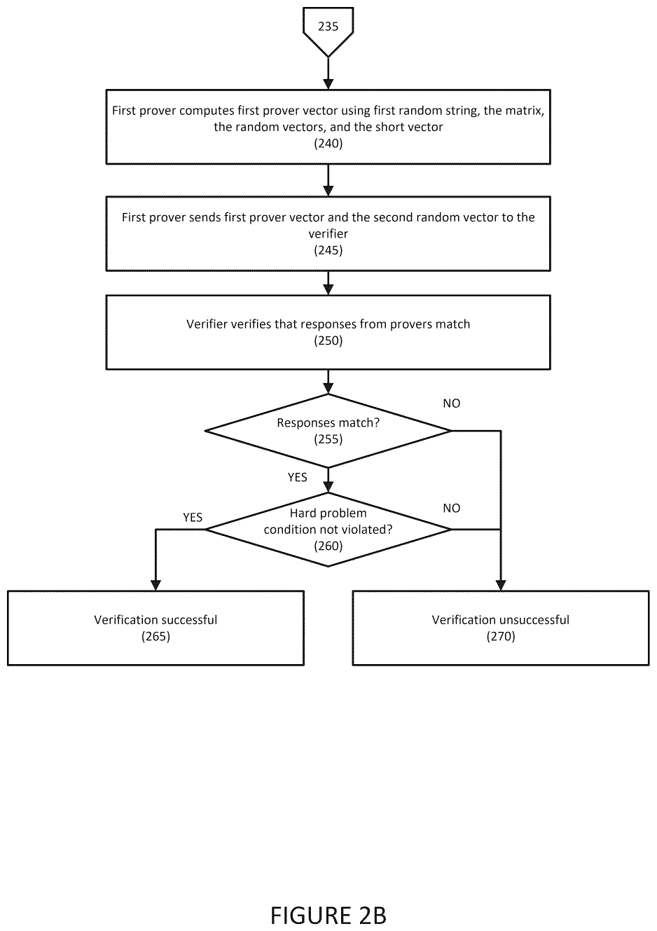

Referring to FIGS. 2A and 2B, a method for relativistic zero-knowledge proof of knowledge for short integer solution problem is disclosed according to an embodiment.

In step 205, a first prover may generate a matrix, [symbol] , and a short vector \vec{s} having a bounded length. Matrix [symbol] has n rows and m columns. Each entry in [symbol] can be chosen uniformly at random from a finite field Z having q elements with values in the range of {0, 1, . . . q−1}. Z_{g} represents non-negative integers modulo q with modular arithmetic.

For example, q is chosen large enough relative to m so that lattice reduction algorithms cannot efficiently find short vector \vec{s} as solution. Meanwhile, since the [symbol] norm of short vector \vec{s} is bounded to β≥\sqrt{nlogq}. If q is too large, trivial solutions exist, and the security is broken. Example values of q may be in the ranges of 2²⁰~2³⁰ and 2⁴⁰~2⁵⁰, corresponding to the security level 128 bit and 256 bit.

Matrix [symbol] plays a role in defining a shifted lattice and constructing hard computational problems of the short integer solution. Here, the shifted lattice L( [symbol] )+\vec{u} is a discrete set of m integers (each in Z_{g}, denoted by \vec{e}={e₁, e₂, . . . eₘ}) linear combinations of basis vectors that satisfies [symbol] \vec{e}=\vec{u}, and the non-zero short vector \vec{s}={s₁, s₂, . . . s₃} is one possible \vec{e} with its [symbol] ₂ norm

$$( i . e . {‖ \vec{s} ‖}_{2} = \sqrt{{\sum }_{i = 1}^{m} {s}_{i}^{2}} )$$

bounded to some beta (β).

The norm bound β and the number m must be large enough that a solution is guaranteed to existed. In the short integer solution, m is greater than nlogq, and B≥\sqrt{nlogq}. This reflects the complexity of finding short solution is a shifted lattice influenced by both the size of dimensions and the number of modulus.

The matrix [symbol] and the short vector \vec{s} may be generated uniformly at random, and the short vector \vec{s} may be a private (i.e., secret) parameter that is known only to the first verifier.

In step 210, the first prover may compute a product vector, \vec{u}= [symbol] \vec{s}, and in step 215, the first prover may make the matrix [symbol] and the product vector \vec{u} known to the second prover and the verifier.

In step 220, the first prover and the second prover may agree to shared randomness. For example, the first prover and the second prover may agree to a first random vector, \vec{z}, and a second random vector, \vec{a}, where \vec{z} has bounded length with large possibility and then are separated apart. The first random vector \vec{z} may be draw uniformly from a normal distribution,

$${N}_{σ}^{m} ,$$

and its [symbol] ₂ norm may be bound with large possibility by property of normal distribution. The second random vector \vec{a} may be generated uniformly from Z.

The first prover and the second prover may be separated after they share this randomness.

In step 225, the verifier may generate a first random string, c, and a second random string, r, and may send them to the first prover and the second prover, respectively. The first random string c may be generated randomly from a challenge space C, which is defined in Z_{q}. A challenge space is a set of possible values that the verifier can choose (i.e., c) and send to the prover. The prover computes the response (i.e., \vec{x}) based on c and sends it back for verification. The challenge space is for the security against cheating provers, i.e., the prover should not be able to predict the challenge in advance. The second random string r may be randomly generated from Z_{q}.

In step 230, the second prover computes a commitment vector, \vec{w}=r [symbol] \vec{z}+\vec{a} using the string r, the first random vector, the second random vector, and the matrix [symbol] .

In step 235, the second prover may send a second prover response including the commitment vector \vec{w} to the verifier.

In step 240, independently but simultaneously, the first prover may compute a first prover vector \vec{x}=c\vec{s}+\vec{z} based on the first random string c, the private short vector \vec{s}, and the first random vector with some abort probability. The abort probability may depend on the normal distribution where shared randomness vector z is drawn.

For example, as the random vector z is sampled from the normal distribution

$${N}_{σ}^{m} ,$$

if \vec{x} is set to equal c\vec{s}+\vec{z}, then \vec{x} might leak information about the secret \vec{s}. Therefore, rejection sampling techniques may be leveraged to help us to adjust the distribution of \vec{x} to avoid leaking information. This may require the corresponding prover (i.e., the first prover) to take the variables (\vec{x}, c\vec{s}) as input to the rejection sampling algorithm. The abort probability defined by the algorithm is:

$$1 - min ( \frac{{N}_{σ}^{m} ( x )}{M {N}_{c s , σ}^{m} ( x )} , 1 ) ( σ denotes the standard deviation )$$

with an existing constant M, where

$$\frac{{N}_{σ}^{m} ( x )}{M {N}_{cs , σ}^{m} ( x )} = \frac{1}{M} exp ( \frac{- 2 〈 x , c s 〉 + {‖ cs ‖}^{2}}{2 {σ}^{2}} ) \leq \frac{1}{M} exp ( \frac{24 ‖ cs ‖ σ + {‖ cs ‖}^{2}}{2 {σ}^{2}} ) = \frac{1 - {2}^{- 100}}{M} . ]$$

In step 245, the first prover may send a first prover response including the first prover vector \vec{x} and the second random vector, \vec{a}, to the verifier. The verifier may measure times t₁ and t₃, the timestamps at which the challenge messages were sent to the first prover and the second prover, respectively, and times t₂ and t₄, the times at which the first prover response and the second prover responses were received, respectively. By fixing the distance Dist between the provers (achieved by splitting the verifier to multiple agents with the same number as provers and fixing at certain locations in practice, not including in algorithm design), the upper bound t may be computed as

$$τ = \frac{D i s t}{c}$$

$$for \vert {t}_{1} - {t}_{4} \vert \leq τ and \vert {t}_{2} - {r}_{3} \vert \leq τ .$$

The verifier may also verify that the responses were all received within a time period. For example, having recorded t₁, t₂, t₃ and t₄, the verifier may use the upper bound to determine if the responses were received within the time period.

In step 250, the verifier may determine whether the responses from the provers match, i.e., if r [symbol] \vec{x}=\vec{w}−\vec{a}+cr\vec{u}.

If, in step 255, the responses match, in step 260, the verifier may verify that the hard problem condition is not violated, i.e., \vec{x} is bounded. For example, the verifier may measure the [symbol] ₂ norm of \vec{x}, i.e., ∥\vec{x}∥₂≤β′.

If the hard problem condition is not violated, in step 265, the verifier may output a value indicating that the verification was successful, such as the value 1.

If the verification passes, then the verifier may grant one or both of the provers some permission, such as password verification. For example, if the prover convinces the verifier that it knows the password then the verifier may allow the prover to use the account.

If the responses do not match, or the hard problem condition is violated, in step 270, the verifier may output a value indicating that the verification was not successful, such as the value 0. This may result in the protocol aborting.

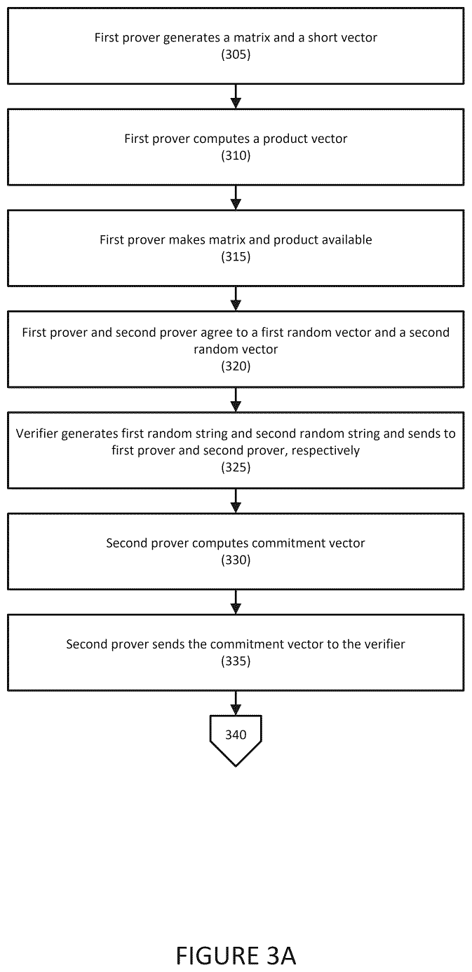

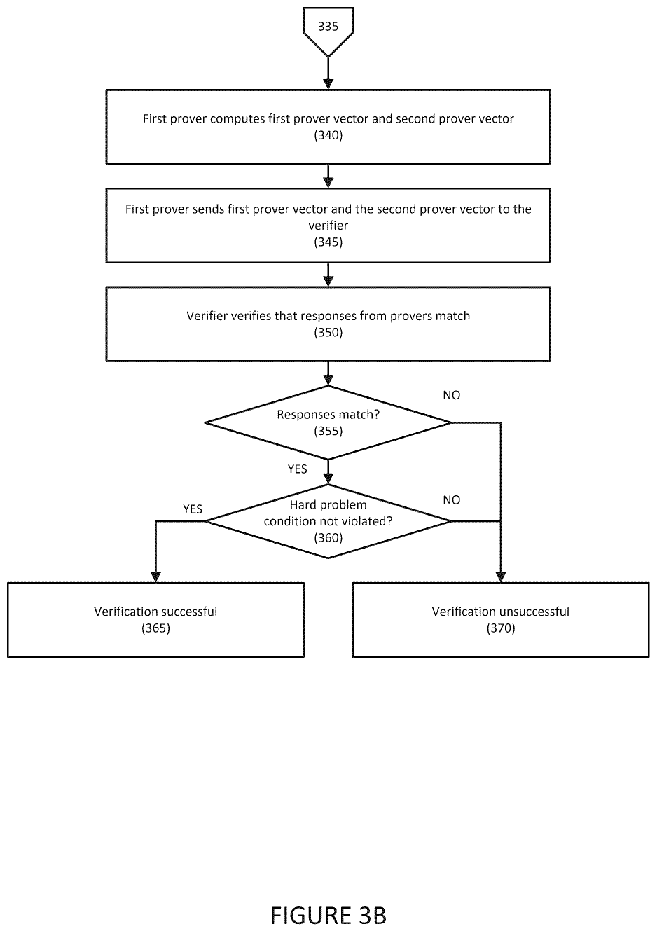

Referring to FIGS. 3A and 3B, a method for relativistic zero-knowledge proof of knowledge for short integer solution problem is disclosed according to another embodiment.

In step 305, a first prover may generate a matrix, [symbol] , and a short vector \vec{s} having a bounded length. This may be similar to step 305, above.

In step 310, the first prover may compute a product vector, \vec{u}= [symbol] \vec{s}, and in step 315, the first prover may make the matrix [symbol] and the product vector u known to the second prover and the verifier. These may be similar to steps 210 and 215, above.

In step 320, the first prover and the second prover may agree to shared randomness. This may be similar to step 220, above.

In step 325, the verifier may generate a first random string, c, and a second random string, r, and may send them to the first prover and the second prover, respectively. This may be similar to step 225, above.

In step 330, the second prover computes a commitment vector, \vec{w}=r\vec{z}+\vec{a} using the string r and the shared randomness.

In step 335, the second prover may send the commitment vector, \vec{w} to the verifier.

In step 340, independently but simultaneously, the first prover may compute a first prover vector \vec{x}=c\vec{s}+\vec{z} based on the first random string c, the private short vector \vec{s}, and the first random vector, and a second prover vector [symbol] \vec{a}, with some abort probability. The abort probability may depend on the normal distribution where shared randomness vector z is drawn.

In step 345, the first prover may send the first prover vector \vec{x} and the second prover vector, [symbol] \vec{d}, to the verifier. The verifier may measure the timing as described above.

In step 350, the verifier may determine whether the responses from the provers match, i.e., if r [symbol] \vec{x}= [symbol] \vec{w}− [symbol] +cr\vec{u}.

In step 355, the responses match, in step 360, the verifier may verify that the hard problem condition is not violated, i.e., \vec{x} is bounded.

If the hard problem condition is not violated, in step 365, the verifier may output a value indicating that the verification was successful, such as the value 1.

If the verification passes, then the verifier may grant one or both of the provers some permission, such as password verification. For example, if the prover convinces the verifier that it knows the password then the verifier may allow the prover to use the account.

If the responses do not match, or the hard problem condition is violated, in step 370, the verifier may output a value indicating that the verification was not successful, such as the value 0. This may result in the protocol aborting.

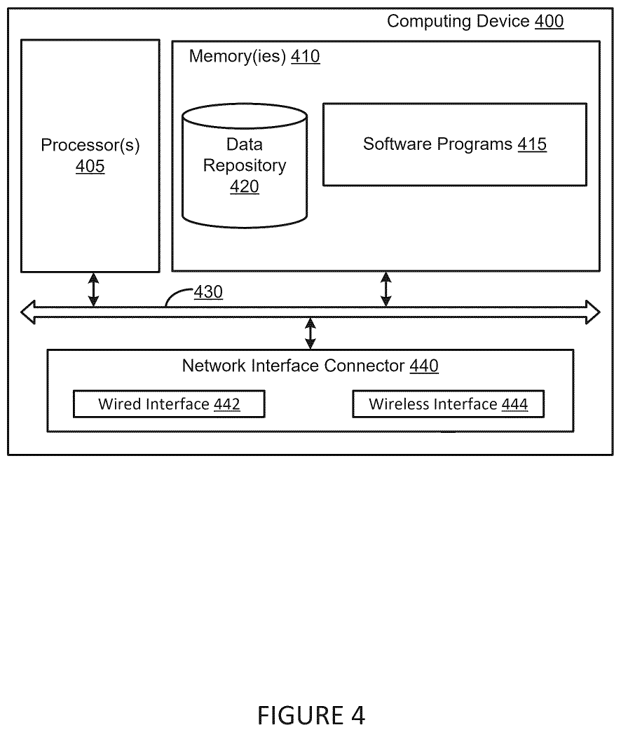

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
generating, by a first prover, a matrix and a short vector, wherein the matrix comprises elements from a finite field of non-negative integers modulo q and the short vector has a bounded length, and the short vector is known only to the first prover;
computing, by the first prover, a product vector from the matrix and the short vector;
sharing, by the first prover, the matrix and the product vector with a second prover and a verifier;
agreeing, by the first prover and the second prover, to a first random vector and a second random vector;
generating, by the verifier, a first random string from a challenge space and a second random string from the finite field of non-negative integers modulo q;
sending, by the verifier, the first random string to the second prover and the second random string to the first prover;
computing, by the second prover, a commitment vector based on the second random string, the matrix, the first random vector, and the second random vector;
sending, by the second prover, a second prover response comprising the commitment vector to the verifier;
computing, by the first prover, a first prover vector based on the first random string, the short vector and the first random vector;
sending, by the first prover, a first prover response comprising the first prover vector and the second random vector to the verifier;
verifying, by the verifier, that the first prover response and the second prover response match;
determining, by the verifier, that the first prover vector is bounded; and
outputting, by the verifier, a value indicating whether the verification was successful.

2. The method of claim 1, further comprising:
confirming, by the verifier, that the first prover response and the second prover response were received within a time period.

3. The method of claim 2, wherein the time period is based on a distance between the first prover and the verifier, and the second prover and the verifier.

4. The method of claim 1, wherein the commitment vector comprises a product of the second random string, the matrix, and the first random vector plus the second random vector.

5. The method of claim 1, wherein the first prover vector comprises a product of the first random string and the short vector plus the first random vector.

6. The method of claim 1, wherein the first prover response and the second prover response match when the product of the second random string, the matrix, and the first prover vector is equal to the commitment vector minus the second random vector plus the product of the first random string, the second random string, and the product vector.

7. A method, comprising:
generating, by a first prover, a matrix and a short vector, wherein the matrix comprises elements from a finite field of non-negative integers modulo q and the short vector has a bounded length, and the short vector is known only to the first prover;
computing, by the first prover, a product vector from the matrix and the short vector;
sharing, by the first prover, the matrix and the product vector with a second prover and a verifier;
agreeing, by the first prover and the second prover, to a first random vector and a second random vector;
generating, by the verifier, a first random string from a challenge space and a second random string from the finite field;
sending, by the verifier, the first random string to the second prover and the second random string to the first prover;
computing, by the second prover, a commitment vector based on the second random string, the matrix, the first random vector, and the second random vector;
sending, by the second prover, a second prover response comprising the commitment vector to the verifier;
computing, by the first prover, a first prover vector based on the first random string, the short vector and the first random vector, and a second prover vector based on the matrix and the second random vector;
sending, by the first prover, a first prover response comprising the first prover vector and the second prover vector to the verifier;
verifying, by the verifier, that the first prover response and the second prover response match;
determining, by the verifier, that the first prover vector is bounded; and
outputting, by the verifier, a value indicating whether the verification was successful.

8. The method of claim 7, further comprising:
confirming, by the verifier, that the first prover response and the second prover response were received within a time period.

9. The method of claim 8, wherein the time period is based on a distance between the first prover and the verifier, and the second prover and the verifier.

10. The method of claim 7, wherein the commitment vector comprises a product of the second random string, the matrix, and the first random vector plus the second random vector.

11. The method of claim 7, wherein the first prover vector comprises a product of the first random string and the short vector plus the first random vector, and the second prover vector comprises a product of the vector and the second random vector.

12. The method of claim 7, wherein the first prover response and the second prover response match when the product of the second random string, the matrix, and the first prover vector is equal to the product of the matrix and the commitment vector minus the product of the vector and the second random vector plus the product of the first random string, the second random string, and the product vector.

13. A system, comprising:
a first prover electronic device executing a first prover computer program;
a second prover electronic device executing a second prover computer program;
a verifier electronic device executing a verifier computer program;
wherein:
the first prover computer program generates a matrix and a short vector, wherein the matrix comprises elements from a finite field of non-negative integers modulo q and the short vector has a bounded length, and the short vector is known only to the first prover;
the first prover computer program computing a product vector from the matrix and the short vector;
the first prover computer program shares the matrix and the product vector with the second prover computer program and the verifier computer program;
the first prover computer program and the second prover computer program agree to a first random vector and a second random vector;
the verifier computer program generates a first random string from a challenge space and a second random string from the finite field of non-negative integers modulo q;
the verifier computer program sends the first random string to the second prover computer program and the second random string to the first prover computer program;
the second prover computer program computes a commitment vector based on the second random string, the matrix, the first random vector, and the second random vector;
the second prover computer program sends a second prover response comprising the commitment vector to the verifier;
the first prover computer program computes a first prover vector based on the first random string, the short vector and the first random vector;
the first prover computer program sends a first prover response comprising the first prover vector and the second random vector to the verifier computer program;
the verifier computer program verifies that the first prover response and the second prover response match;
the verifier computer program determines that the first prover vector is bounded; and
the verifier computer program outputs a value indicating whether the verification was successful.

14. The system of claim 13, wherein the verifier computer program confirms that the first prover response and the second prover response were received within a time period.

15. The system of claim 14, wherein the time period is based on a distance between the first prover electronic device and the verifier electronic device, and the second prover electronic device and the verifier electronic device.

16. The system of claim 13, wherein the commitment vector comprises a product of the second random string, the matrix, and the first random vector plus the second random vector.

17. The system of claim 13, wherein the first prover vector comprises a product of the first random string and the short vector plus the first random vector.

18. The system of claim 13, wherein the first prover response and the second prover response match when the product of the second random string, the matrix, and the first prover vector is equal to the commitment vector minus the second random vector plus the product of the first random string, the second random string, and the product vector.
